(19) United States
(12) Patent Application Publication
(10) Pub. No.: US 2023/0085144 A1
(43) Pub. Date: Mar. 16, 2023

(54) SYSTEM AND METHOD FOR REAL-TIME MANAGEMENT OF DATA RECORDS

(71) Applicant: The Toronto-Dominion Bank, Toronto (CA)

(72) Inventors: Mark Lawrence BILODEAU, Auburn, ME (US); Redford SanJuan WASHINGTON, Greenville, SC (US)

(73) Assignee: The Toronto-Dominion Bank, Toronto (CA)

(21) Appl. No.: 17/475,566

(22) Filed: Sep. 15, 2021

(51) Int. Cl. G06Q 40/08; G06F 16/22; G06F 9/54

(52) U.S. Cl. CPC G06Q 40/08; G06F 16/22; G06F 9/54

(57) ABSTRACT

A method for real-time processing of resource requests is disclosed. The method includes: obtaining a filtered data record set based on filtering a set of a plurality of data records using first filter criteria; determining, using a robotic process automation system, that a first data record in the filtered data record set is associated with a first category of data records, the robotic process automation system being configured to determine categories associated with respective data records using second filter criteria different from the first filter criteria; and store, in memory, a flag in association with the first data record, wherein flagging of the first data record causes a notification to be generated for transmission to a computing device associated with the first data record, the notification identifying an action to be taken in connection with the first data record.

### TECHNICAL FIELD

The present disclosure relates to data processing systems and, in particular, to systems and methods for accessing, modifying and otherwise managing data records of a database.

### BACKGROUND

Resource servers, or servers that are associated with resource lender entities, may receive and process resource requests from various computing systems. Such servers may automatically process the resource requests and provide lending decisions to retailer computing systems and/or client devices associated with prospective purchasers. The resource requests are typically associated with resource accounts. In particular, a borrower entity may request to receive a transfer of resources (e.g., data) to one or more data records associated with a resource account of the borrower entity. Manual processing of the data records for managing resource requests data may result in unintended errors or delays. Any delays which may be introduced by such manual processing can cause subsequent processes and actions to be delayed or fail entirely.

### BRIEF DESCRIPTION OF DRAWINGS

Reference will now be made, by way of example, to the accompanying drawings which show example embodiments of the present application and in which:

FIG. 1 is a schematic diagram illustrating an operating environment of an example embodiment of the present disclosure;

FIG. 2A is a high-level schematic diagram of an example computing device;

FIG. 2B shows a simplified organization of software components stored in memory of the example computing device of FIG. 2A;

FIG. 3 shows, in flowchart form, an example method for accessing and modifying a data record of a database;

FIG. 4 shows, in flowchart form, another example method for accessing and modifying a data record of a database; and

FIG. 5 shows, in flowchart form, an example method for providing notifications to an entity associated with a data record of a database.

Like reference numerals are used in the drawings to denote like elements and features.

### DETAILED DESCRIPTION OF EXAMPLE EMBODIMENTS

In one aspect, the present disclosure describes a computing device. The computing device includes a processor, a communications module coupled to the processor, and a memory coupled to the processor. The memory stores instructions that, when executed, configure the processor to: obtain a filtered data record set based on filtering a set of a plurality of data records using first filter criteria; determine, using a robotic process automation system, that a first data record in the filtered data record set is associated with a first category of data records, the robotic process automation system being configured to determine categories associated with respective data records using second filter criteria different from the first filter criteria; and store, in the memory, a flag in association with the first data record, wherein flagging of the first data record causes a notification to be generated for transmission to a computing device associated with the first data record, the notification identifying an action to be taken in connection with the first data record.

In some implementations, the filtered data record set may include only those data records that satisfy all defined criteria of the first filter criteria.

In some implementations, the first filter criteria may define a single payment delinquency period for all of the plurality of data records and the second filter criteria may define individualized payment delinquency periods for respective ones of the plurality of data records.

In some implementations, the instructions, when executed, may further configure the processor to determine an individualized payment delinquency period for at least one of the data records in the filtered data record set based on a risk rating associated with the at least one data record.

In some implementations, the individualized payment delinquency period for the at least one data record may be determined to be a shorter period if the at least one data record is associated with an entity that is associated with a high risk rating.

In some implementations, the instructions, when executed, may further configure the processor to automatically modify one or more defined criteria of the first filter criteria.

In some implementations, the instructions, when executed, may further configure the processor to: determine that a data record in the filtered data record set has insufficient data for determining whether the data record belongs to the first category; and add a record identifier associated with the data record to a defect list stored in the memory.

In some implementations, evaluating data records using the second filter criteria may include obtaining, from a remote server system, additional information in connection with the data records that is not stored in the memory.

In some implementations, obtaining the additional information may include transmitting one or more queries to the remote server system using application programming interface (API) calls.

In some implementations, storing the flag in association with the first data record may include indicating one or more defined conditions associated with the action, the one or more defined conditions being different from the second filter criteria.

In another aspect, a computer-implemented method is disclosed. The method includes: obtaining a filtered data record set based on filtering a set of a plurality of data records using first filter criteria; determining, using a robotic process automation system, that a first data record in the filtered data record set is associated with a first category of data records, the robotic process automation system being configured to determine categories associated with respective data records using second filter criteria different from the first filter criteria; and store, in memory, a flag in association with the first data record, wherein flagging of the first data record causes a notification to be generated for transmission to a computing device associated with the first data record, the notification identifying an action to be taken in connection with the first data record.

In yet another aspect, a non-transitory computer readable storage medium is disclosed. The computer readable storage medium contains instructions thereon which, when executed by a processor, configure the processor to: obtain a filtered data record set based on filtering a set of a plurality of data records using first filter criteria; determine, using a robotic process automation system, that a first data record in the filtered data record set is associated with a first category of data records, the robotic process automation system being configured to determine categories associated with respective data records using second filter criteria different from the first filter criteria; and store, in the memory, a flag in association with the first data record, wherein flagging of the first data record causes a notification to be generated for transmission to a computing device associated with the first data record, the notification identifying an action to be taken in connection with the first data record.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Requests to obtain resources may be received and processed by resource lender systems. These systems may adjudicate resource requests based on defined criteria, such as adjudication rule sets. For example, nodes of a computer network may generate and send requests to acquire additional computing resources from a network resource management system, and the system may determine how to allocate the resources of the network. As another example, applications to receive loans (e.g., mortgages) that are in the form of resource requests may be directed to a financial institution server (and more generally, a loan originating system). A loan adjudication entity associated with the financial institution may approve or deny a loan application.

When a borrower entity fails to comply with requirements of a resource loan (e.g., failure to return borrowed resources or to make payments on a loan), the lender entity may wish to pursue certain actions. For example, a lender entity may initiate a process of repossessing property (e.g., a vehicle) that is associated with, or tied to, the resource loan. The lender entity may send a notice to the borrower entity indicating one or more required actions and associated deadlines for compliance. The monitoring of resource accounts (and associated data records) for compliance with requirements of resource loans has historically been performed manually. Such manual processing can be a prolonged process, particularly when a large volume of loans is handled by a small number of resource management entities. Moreover, a manual evaluation of resource accounts/data records may be based on limited data sets or data sets with missing or erroneous data, resulting in incorrect processing of the resource accounts/data records.

The present application discloses solutions for automatically processing data records to adjudicate compliance with requirements of resource loans associated with the data records. Specifically, a computing system associated with a resource loan adjudicating entity is described. The computing system obtains a filtered data record set based on filtering a set of a plurality of data records using first filter criteria. The first filter criteria may, for example, relate to specific requirements of resource loans that are associated with the data records. Using a robotic process automation (RPA) system, the computing system determines that a first data record in the filtered set is associated with a first category of data records. The RPA system is configured to determine categories associated with respective data records using second filter criteria different from the first filter criteria. Upon determining that the first data record is associated with the first category, the computing system stores, in memory, a flag in association with the first data record, causing a notification to be generated for transmission to a computing device associated with the first data record. The notification may, for example, identify an action that is required to be taken in connection with the first data record (e.g., for compliance with requirements of associated resource loan(s)).

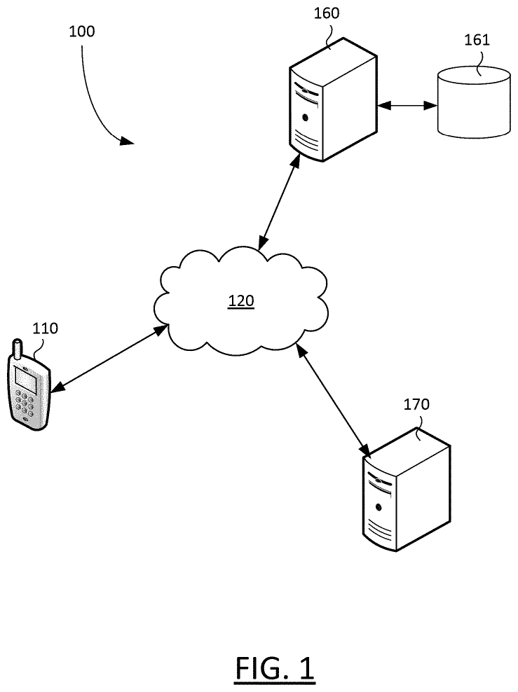

FIG. 1 is a schematic diagram illustrating an operating environment of an example embodiment. In particular, FIG. 1 illustrates exemplary components of a system 100 for processing resource requests data associated with resource accounts. As a specific example, the system 100 of FIG. 1 may be implemented to facilitate processing of resource loan data in connection with data records (and associated resource accounts) of borrower entities.

As illustrated, a resource server 160 (which may also be referred to as a server computer system) and client device 110 communicate via the network 120. The client device 110 is a computing device that may be associated with an entity, such as a user or client, having resources associated with the resource server 160. The client device 110 may take a variety of forms including, for example, a mobile communication device such as a smartphone, a tablet computer, a wearable computer such as a head-mounted display or smartwatch, a laptop or desktop computer, or a computing device of another type.

The resource server 160 may track, manage, and maintain resources, make lending decisions, and/or lend resources to the entity. The resources may, for example, be computing resources, such as memory or processor cycles. By way of further example, the resources may include stored value, such as fiat currency, which may be represented in a database. For example, the resource server 160 may be coupled to a database 161, which may be provided in secure storage. The secure storage may be provided internally within the resource server 160 or externally. The secure storage may, for example, be provided remotely from the resource server 160. For example, the secure storage may include one or more data centers. The data centers may, for example, store data with bank-grade security.

In some embodiments, the system 100 may include a resource lending adjudication server (not shown in FIG. 1) that is independent of the resource server 160. A resource lending adjudication server may implement a service which receives resource requests and automatically processes the resource requests to render resource lending approval data for requesting entities. This adjudication service may be implemented by a server that is different from the resource server 160. For example, a resource lending adjudication server that is communicably connected to the resource server 160 and has access to resource accounts data that is maintained by the resource server 160 may be configured to provide an adjudication service for resource requests. In some embodiments, the resource server 160 may itself implement a resource lending adjudication service. For example, the resource server 160 may include a software module that performs the functions of the resource lending adjudication service. The module may be configured to, for example, process the resource requests that are associated with data records maintained (and/or managed) by the resource server 160.

The database 161 may include data records for a plurality of accounts and at least some of the data records may define a quantity of resources associated with an entity. For example, the entity that is associated with the client device 110 may be associated with an account having one or more data records in the database. The data records may reflect a quantity of stored resources that are associated with the entity. Such resources may include owned resources and, in at least some embodiments, borrowed resources (e.g., resources available on credit). The quantity of resources that are available to or associated with an entity may be reflected by a balance defined in an associated data record such as, for example, a bank balance.

The resource server 160 may, for example, be a financial institution server that is operated by a financial institution and the entity may be a customer of the financial institution.

The client device 110 may be used, for example, to configure a data transfer from an account associated with the client device 110. More particularly, the client device 110 may be used to configure a data transfer from an account associated with an entity operating the client device 110. The data transfer may involve a transfer of data between a data record in the database 161 associated with such an account and another data record in the database 161 (or in another database such as a database associated with another server that is coupled to the resource server 160 via a network). The other data record may be associated with a data transfer recipient such as, for example, a bill payment recipient. The data involved in the transfer may, for example, be units of value and the data records involved in the data transfer may be adjusted in related or corresponding manners. For example, during a data transfer, a data record associated with the data transfer recipient may be adjusted to reflect an increase in value due to the transfer whereas the data record associated with the entity initiating the data transfer may be adjusted to reflect a decrease in value which is at least as large as the increase in value applied to the data record associated with the data transfer recipient.

The resource server 160 may be in communication with a resource usage tracking server 170 via the network 120. The resource usage tracking server 170 may maintain a history of resource borrowing by various entities including, for example, the entity associated with the client device 110 and associated with an account having one or more data records in the database 161.

Additionally, or alternatively, the resource usage tracking server 170 may maintain historical resource usage data associated with the various entities. Such data may be maintained on a per-entity basis, with each entity having its own associated historical resource usage data. The historical resource usage data may identify, for example, third parties that have a credit relationship with the entity associated with a particular instance of the historical resource usage data, such as a particular record of the historical resource usage data. The historical resource usage data may, for example, be a credit report. A credit report is a record of a borrower's credit history from a number of sources including, for example, credit card companies, banks, collection agencies and/or governments. A credit score, which is a numerical representation of a borrower's creditworthiness, may be obtained based on a credit report. The historical resource usage data, such as the credit report, may identify various resource event data including, any one or a combination of: a borrowed resource history (e.g., a credit history), a resource transfer history (e.g., a record of payments including, for example, an indication of whether such payments were on time or late), failed transfer information (e.g., information regarding cheques that were returned for having non-sufficient funds and/or information about accounts that were sent to a collection agency, bureau or process due to non-transfer of resources), resource shortage information (e.g., data regarding prior bankruptcies or other data indicating that an entity had insufficient resources to satisfy data transfer requirements), borrowed resource information (e.g., information about loans including secured and unsecured loans), and/or data of another type.

In some embodiments, the resource event data may include a third-party identifier. The third-party identifier may, for example, be a name of a third party that is associated with such data. The name of a third party that added or caused to be added an entry to the historical resource usage data may be identified. By way of example, the resource transfer history may identify a plurality of third parties who have a past history of requesting and/or receiving transfers from the entity. By way of further example, the failed transfer information may identify a third party that was to be the recipient of the failed transfer. By way of further example, the borrowed resource information may identify a third party that previously lent resources to the entity.

In some embodiments, the resource event data may include identification information that a defined third-party would associate with the entity. For example, an account number, a partial account number, or other customer identifier may be included in the historical resource usage data. By way of example, the historical resource usage data may indicate that a given third party (e.g., “The Phone Company”) identifies the entity with a defined account number (e.g., 798126).

The historical resource usage data may include other information instead of or in addition to the information defined above. For example, the historical resource usage data may include a listing of third parties that have previously retrieved and/or requested historical resource usage data maintained by the resource usage tracking server 170 (e.g., a listing of third parties that previously requested a credit report). By way of further example, the historical resource usage data may include identification and/or biographical information for the entity. Such information may include, for example, any one or more of: a name, address, date of birth, marital status, current and/or past employment information (e.g., a title, a date of employment, income amount, name of employer, etc.), contact information (such as a telephone number, etc.), a government issued identification number (e.g., a social insurance number (SIN), a passport number and/or driver's license number), or other information.

Various entries of data, such as, for example, the resource event data, may include a date associated therewith. The date may, for example, be a reporting and/or verification date. The date may reflect freshness of the associated entry of data such that entries with a more recent date may be considered to be fresher than entries with an older date.

The resource usage tracking server 170 may include an application programming interface (API) that allows the resource server 160 to request for and receive historical resource usage data for an entity. By way of example, the API may allow the resource server 160 to retrieve the historical resource usage data for an entity by sending a message which includes identification information for the entity to the resource usage tracking server 170. The identification information may, for example, include any one or combination of: a name, government issued identification number, an address, a date of birth, contact information (e.g., a telephone number), or identification of another type. The resource usage tracking server 170 uses such identification information to retrieve a historical resource usage data associated with the entity. For example, an appropriate record in a database may be retrieved based on the identification information. The resource usage tracking server 170 may then send the historical resource usage data for the entity to the resource server 160.

As described above, the client device 110, the resource server 160, and the resource usage tracking server 170 may be computer systems. The client device 110, the resource server 160, and the resource usage tracking server 170 may be in geographically disparate locations. Put differently, the client device 110 may be remote from at least one of the resource server 160 and the resource usage tracking server 170.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

In the example of FIG. 1, the resource server 160 may provide both data transfer processing (e.g., bill payment) and data holding (e.g., banking) functions. That is, the resource server 160 may be both a financial institution server and also a bill payment processing server. The resource server 160 may, in some embodiments, be a proxy server, serving as an intermediary for requests for client devices 110 seeking resources from other servers.

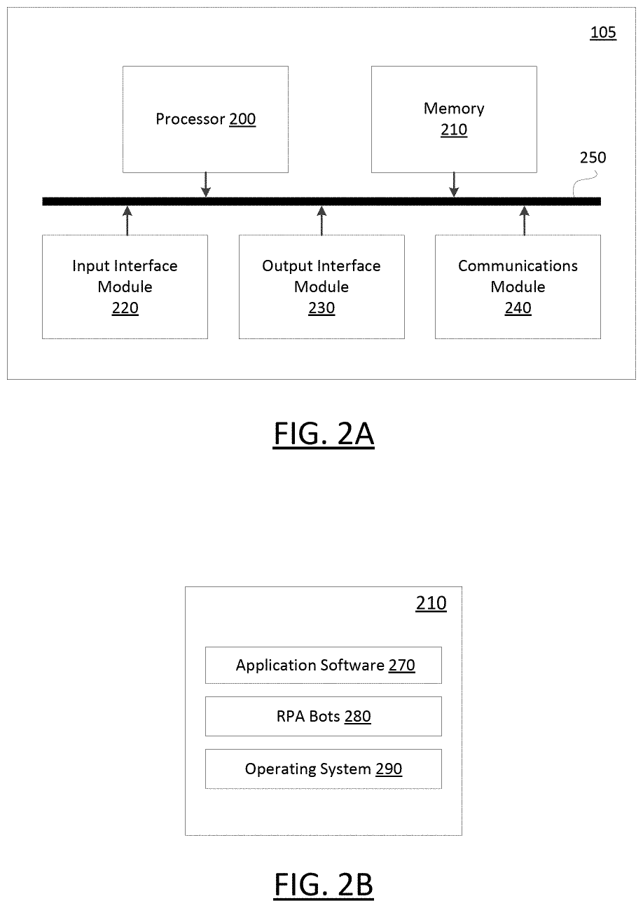

FIG. 2A is a high-level operation diagram of the example computing device 105. In at least some embodiments, the example computing device 105 may be exemplary of one or more of the client device 110, the resource server 160, and the resource usage tracking server 170. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components may include application software 270, robotic process automation (RPA) bot(s) 280, and an operating system 290.

The application software 270 adapts the example computing device 105, in combination with the operating system 290, to operate as a device performing particular functions. While a single application software 270 is illustrated in FIG. 2B, in operation, the memory 210 may include more than one application software 270 and different application software 270 may perform different operations.

In the example of FIG. 2B, the example computing device 105 includes one or more RPA bots 280, or software robots, that are executable by a processor (such as processor 200). The RPA bots 280 may be configured to perform various robotic tasks, based on instructions that are defined for the tasks and stored, for example, in the memory 210. An RPA bot 280 may be associated with one or more sub-bots or routines, which may also be stored in the memory 210. Upon completion of a robotic task, the RPA bots 280 may generate specific output(s) or otherwise notify a computing system that the task has been completed.

The operating system 290 is software. The operating system 290 allows the application software 270 and RPA bots 280 to access the processor 200, the memory 210, the input interface module 220, the output interface module 230 and the communications module 240. The operating system 290 may be, for example, Apple iOS™, Google™'s Android™, Linux™, Microsoft™ Windows™, or the like.

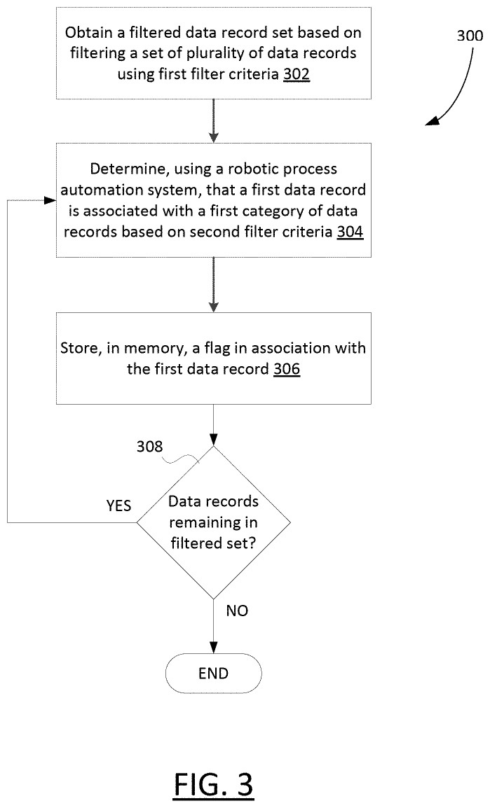

Reference is made to FIG. 3, which shows, in flowchart form, an example method 300 for accessing and modifying data records of a database. A computing system may manage data records of a plurality of resource accounts, in accordance with method 300. In particular, a computing system may implement the method 300 (or parts thereof) when adjudicating compliance of data records with requirements of resource loans associated with the data records. For example, the method 300 may enable a computing system to update or modify data records based on processing resource loans data associated with the data records.

Operations 302 and onward are performed by one or more processors of a computing device such as, for example, the processor 200 (FIG. 2) of a suitably configured instance of the example computing device 105 (FIG. 2). The method 300 may be performed, for example, by a server that has access to and manages data records of a plurality of resource accounts. In particular, a server configured for managing resource accounts, such as the resource server 160, may implement the method 300.

A server associated with a resource management entity may process data records associated with a plurality of resource accounts maintained or managed by the entity. In operation 302, the server obtains a filtered data record set based on filtering a plurality of the data records using first filter criteria. The server generates a list, or subset, of data records based on the first filter criteria. In particular, the server identifies those data records (and associated resource accounts) that satisfy the first filter criteria.

In at least some embodiments, the server may evaluate account data associated with the resource accounts/data records in determining whether a data record satisfies the first filter criteria. The first filter criteria may include, for example, one or more defined rules or conditions associated with resource requests. The server may obtain values of one or more data fields associated with data records and compare the values to rules of the first filter criteria. The values may, for example, be stored in memory in association with the data fields. The data fields may relate to historical activity in connection with the data records. In some embodiments, resource request data for one or more resource requests associated with the data records may be stored in association with the data records. For example, various data associated with resource requests to receive resources (e.g., data) for a data record may be stored in memory. The resource request data for a resource request may include, for example, a quantity of resources requested and/or obtained, a timestamp associated with the resource request, a source/transferor of resources, a type of resource transfer, a repayment period, and the like.

The first filter criteria represent a broad set of criteria (or rules, requirements, conditions, etc.) that are used for an initial selection of a subset of data records for further processing. In at least some embodiments, the filtered data record set includes only those data records that satisfy all defined criteria of the first filter criteria. That is, the data records of the filtered set may include only those data records that satisfy each criterion of the first filter criteria.

By way of example, the first filter criteria may relate to resource loans associated with data records. A resource loan represents a transfer or allocation of resources to a resource account (and associated data records) in connection with a request to obtain resources from a lender entity. The first filter criteria may, for example, define a threshold delinquency period, or a payment overdue period, associated with resource loans. For each of the plurality of data records, the value of a data field defining a delinquency period of a resource loan associated with the data record may be compared to the threshold period included in the first filter criteria. A data record (or associated resource account) that has a value of a delinquency period exceeding the threshold period may be included in the filtered set of data records. The filtered data record set may comprise all of the data records having at least one associated resource loan with a delinquency period that exceeds the threshold period. More generally, the filtered data record set may include any of the plurality of data records that satisfies defined criteria of the first filter criteria, and exclude those data records that do not satisfy any of the first filter criteria.

The filtered list or subset of data records may take various forms. For example, the list/subset may be in the form of a document (e.g., spreadsheet). In particular, the list/subset may be provided in a document that contains identifying information for the data records included in the filtered set.

In operation 304, the server determines, using a robotic process automation system, that a first data record in the filtered data record set is associated with a first category of data records. In at least some embodiments, one or more RPA bots may be employed to operate on the filtered data record set. In particular, the RPA bots are configured to determine categories associated with respective data records using second filter criteria that are different from the first filter criteria. The RPA bots are software components, or modules, that are associated with the server. For example, the RPA bots may comprise software instructions that are stored in a memory associated with the server. The RPA bots may evaluate values of data fields associated with the data records in order to determine which of the filtered set of data records are associated with the first category based on the second filter criteria.

In at least some embodiments, the second filter criteria represent criteria (or rules, requirements, conditions, etc.) that are narrower than the first filter criteria. Put differently, the second filter criteria may be defined such that the number of data records satisfying the second filter criteria is smaller than the number of data records satisfying the first filter criteria. By way of example, in some embodiments, the first filter criteria may define a single payment delinquency period for all of the plurality of data records and the second filter criteria may define individualized payment delinquency periods that are relevant for respective ones of the plurality of data records.

The first filter criteria may be modifiable, such that the processing load of the RPA bots may be controlled. More particularly, the amount of processing resources that are to be used by the RPA bots may be controlled by suitably adjusting/defining the first filter criteria. In some embodiments, the first filter criteria may be adjusted automatically. For example, the server may adjust the first filter criteria automatically in response to detecting at least one trigger condition. The trigger conditions may relate to a processing load associated with the one or more RPA bots. For example, if the processing load of at least one of the RPA bots exceeds a defined threshold level, the first filter criteria may be automatically modified to restrict the set of data records on which the RPA bots will operate, using the first filter criteria. Additionally, or alternatively, the first filter criteria may be modified manually, for example, in response to a command or another user input for managing the filter criteria associated with the RPA bots.

In at least some embodiments, the server may obtain, from one or more remote server systems, additional information in connection with the data records that is not stored in memory accessible by the server. By way of example, the server may transmit one or more queries to a remote server system to obtain additional information in connection with one or more of the data records. The queries may be transmitted, for example, using application programming interface (API) calls defined for the remote server systems. The remote server system may be, in some embodiments, a computing system storing data of resource requests/loans associated with one or more of the plurality of data records. For example, the remote server system may be a third-party server that stores product data of products. The third-party server may store, for example, product data for a product to which a resource loan associated with a data record is tied (e.g., a financing application). The third-party server may store various product data including, among others, product identifier, price, year, make, model, etc.

Additionally, or alternatively, the server may obtain, from one or more third-party servers that maintain profiles associated with resource requesting entities, profile data which may be used by the RPA bots for evaluating data records of the filtered set. The profile data of a resource requesting entity associated with a data record may include, for example, product data of products that are tied to resource loans associated with the entity, identifying information (e.g., gender, profession, etc.) of the entity, and status, conditions (e.g., health data) or other properties associated with the entity.

The server may evaluate the data records of the filtered set in various different ways to determine categories associated with the data records. In particular, the server may compute values of one or more metrics in determining whether a data record falls under the first category. For example, the server may determine, for each of the data records, one or more threshold delinquency periods associated with the data record. A threshold delinquency period may refer to a length of time after a resource loan is processed when an action for causing repayment (e.g., a resource transfer) in connection with the resource loan may be initiated. A threshold delinquency period associated with a data record can be used to categorize the data record. In particular, the data records of the filtered set may be categorized by comparing the threshold delinquency period(s) of each data record to one or more predefined values. If at least one of the delinquency periods for a data record is determined to exceed a predefined threshold, the data record may be classified as falling in the first category. That is, if at least one of the resource loans associated with a data record has a delinquency period exceeding a defined threshold, the data record may be determined to be associated with the first category.

In at least some embodiments, the server may determine a risk rating associated with a data record and determine a threshold delinquency period for the data record based on the risk rating. A risk rating may be a rating that is assigned to the at least one data record/resource account, an entity (e.g., customer) associated with the at least one data record, or a resource loan associated with the at least one data record. The risk rating may be dependent on, for example, a credit rating of the entity associated with the at least one data record, other assets associated with the entity, and the like. For example, a risk rating associated with an owner of a data record/resource account may be determined based on a credit rating obtained by querying a third-party server, such as the resource usage tracking server 170 of FIG. 1. More generally, a risk rating may be determined based on account data of a resource account associated with the entity. A higher risk rating may correspond to a shorter threshold delinquency period. That is, an individualized payment delinquency period for a first data record may be shorter than that for a second data record if the first data record is associated with a higher risk rating compared to the second data record.

In operation 306, the server stores, in a memory, a flag in association with the first data record. In at least some embodiments, the flagging of a data record or associated resource account may include accessing and/or modifying account data of the resource account. For example, the server may access and update the first data record to include a flag object (or another data field entry) for indicating that the first data record is associated with the first category. The flag object may include data identifying, for example, a resource loan associated with the first data record, a criterion satisfied by the first data record, and/or a follow-up action to initiate in connection with the resource loan.

The flagging of the first data record causes a notification to be generated for transmitting to a computing device associated with the first data record. The notification may be generated by the server or another computing system that is communicably connected to the server. For example, a server associated with a third-party vendor may be caused to send the notification to a device associated with the owner of the first data record. The third-party vendor may, for example, be a vendor of an asset or product for which a resource loan is obtained for the first data record. The notification may identify an action that is to be taken in connection with the first data record. Specifically, the notification may include an indication of a follow-up action (such as repossession of property, and the like) to initiate in connection with a resource loan associated with the first data record.

For example, the notification and/or the flag associated with the first data record may indicate that a repossession action (i.e., an action of repossessing a property associated with a resource loan) may be initiated for the first data record. The flag may comprise a repossession loss notice indicator for the first data record. In some embodiments, the indicator may include additional information. For example, the indicator may include an indication of the follow-up action and a time period (e.g., due date and time) associated with the follow-up action.

As another example, the indicator may include an indication of one or more exceptions to defined rules (such as the first and second filter criteria) that are relevant for the first data record. In particular, if the server determines that certain exceptions are defined for the first data record, the server may flag the first data record for special handling that is different from handling of other data records by the server. For example, the RPA bots associated with the server may query a remote computing system to obtain information about an entity (e.g., customer) associated with the first data record. If the RPA bots determined, based on the obtained entity information, that certain defined criteria are satisfied by the entity, the first data record may be flagged as requiring handling (e.g., follow-up actions) that are different from the data records associated with other entities that do not satisfy such criteria. In at least some embodiments, the indicator (e.g., flag) may identify the criteria (or exceptions, etc.).

Additionally, or alternatively, the server may indicate one or more defined conditions associated with the follow-up action(s) that may be initiated for the first data record. The defined conditions may, for example, be different from the second filter criteria. For example, the notification that is generated may indicate one or more restrictions on initiating the follow-up action for the first data record. The restrictions may comprise a definition of exceptions that, if applicable to the first data record, would prevent or limit the follow-up action in connection with a resource loan.

After the server evaluates the first data record, it may then evaluate other data records of the filtered data record set, in operation 308. In particular, the evaluation of data records and associated resource loan data continues until all data records of the filtered data record set have been processed. That is, the server is configured to iterate through the data records to identify those data records that satisfy defined criteria (i.e., second filter criteria). For each data record that is identified in this manner, the server may flag the data record by, for example, storing a flag object in association with the data record. The computing devices associated with the flagged data records may subsequently be notified. Specifically, notifications that indicate one or more actions to be taken in connection with the flagged data records may be transmitted to the devices of entities (e.g., customers) associated with the data records.

In some embodiments, the server may determine that a particular data record in the filtered data record set has insufficient data for determining whether the data record belongs to the first category. For example, an RPA bot is unable to evaluate a data record or associated resource account because requisite data is missing from the account data or is unavailable from any related third-party systems. In these cases, the data record/resource account may be added to a defect list that is stored in memory. For example, a record identifier associated with the data record may be added to a defect list, which may be reviewed either manually or automatically in accordance with defined rules.

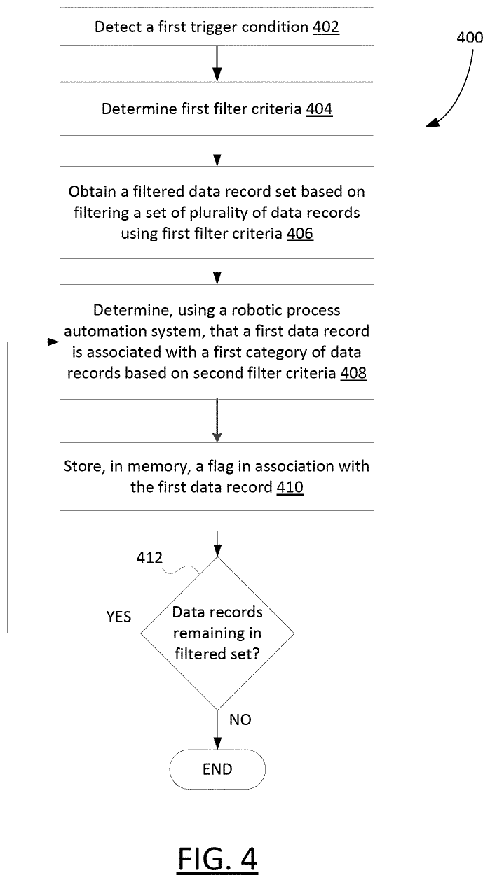

Reference is made to FIG. 4, which shows, in flowchart form, another example method 400 for accessing and modifying data records of a database. A computing system may manage data records of a plurality of resource accounts, in accordance with method 400. Operations 402 and onward are performed by one or more processors of a computing device such as, for example, the processor 200 (FIG. 2) of a suitably configured instance of the example computing device 105 (FIG. 2). The method 400 may be performed, for example, by a server that has access to and manages data records of a plurality of resource accounts. In particular, a server that is configured for managing resource accounts, such as the resource server 160, may implement the method 400. For example, a computing system may implement the method 400 (or parts thereof) when adjudicating compliance of data records with requirements of resource loans associated with the data records. The operations of method 400 may be performed in addition to, or as alternatives of, one or more operations of method 300.

A server associated with a resource management entity may process data records associated with a plurality of resource accounts maintained or managed by the entity. In particular, the server may process the data records to evaluate compliance with defined requirements of resource loans associated with the data records. In operation 402, the server detects a trigger condition. In some embodiments, the trigger condition may relate to a processing load of the server and/or associated software modules of the server. For example, the server may detect that a quantity of processing resources currently used by the server and its software modules exceeds a defined threshold amount. As another example, the server may detect that a number of data records being handled by the server exceeds a defined threshold number. In particular, the server may detect a trigger condition upon determining that there is a greater-than-threshold number of data records being processed by the server.

The trigger condition of operation 402 may be defined so that the processing load of the server can be controlled. By using suitably defined trigger conditions, the server can maintain a desired level of processing load when processing the data records for evaluating compliance with resource loan requirements.

In operation 404, the server determines first filter criteria. The first filter criteria are used in deriving a subset of the plurality of data records for further processing. In particular, the server determines filter criteria that are associated with the detected trigger condition. That is, the first filter criteria may depend on the trigger condition that is detected in operation 402. The first filter criteria may be defined such that a desirable number, or types, of data records are operated on the server. That is, the number and/or types of data records for processing by the server may be controlled by defining or suitably adjusting the first filter criteria.

Operations 406, 408, 410 and 412 correspond to operations 302, 304, 306 and 308, respectively, of method 300 and may be performed in a similar manner as those operations as described above. Specifically, one or more robotic process automation (RPA) bots associated with the server may operate on a filtered data record set that is obtained by filtering the plurality of data records using the first filter criteria. The RPA bots operate on the filtered data record set in order to identify those data records (and associated resource accounts) for which certain defined actions should be initiated. In particular, the RPA bots may be configured to flag the data records associated with resource loans for which one or more follow-up actions should be taken.

As described with reference to FIGS. 3 and 4, a server that processes a plurality of data records for evaluating compliance with resource loan requirements may be configured to automatically determine and/or adjust filter criteria for deriving an initial subset of data records in order to manage a processing load on the server (and associated software modules, such as RPA bots). The server may thus be configured to continuously monitor certain metrics (e.g., processing load, computing resource availability, etc.) associated with the server and determine suitable filter criteria based on values of the metrics.

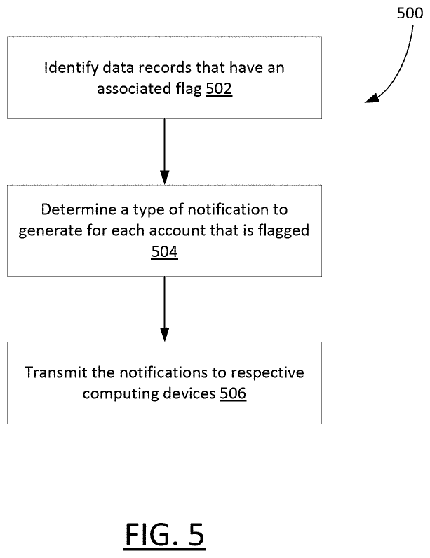

Reference is made to FIG. 5, which shows, in flowchart form, an example method 500 for providing notifications to an entity associated with a data record of a database. In particular, the method 500 may enable a computing system to notify entities associated with data records regarding actions that are to be performed in connection with the data records.

Operations 502 and onward are performed by one or more processors of a computing device such as, for example, the processor 200 (FIG. 2) of a suitably configured instance of the example computing device 105 (FIG. 2). The method 500 may be performed, for example, by a server that has access to and manages data records of a plurality of resource accounts. In particular, a server that is configured for managing resource accounts, such as the resource server 160, may implement the method 500. The operations of method 500 may be performed in addition to, or as alternatives of, one or more operations of methods 300 and 400. More specifically, the operations of method 500 may be performed as sub-routines of operations 306 or 410 of methods 300 and 400, respectively.

In operation 502, the server identifies data records and/or resource accounts that have an associated flag. The flags may indicate, for example, certain actions to perform in connection with the data records. The data records may be flagged based on the filtered processing technique described above with reference to methods 300 and 400. In particular, the data records may be categorized, or flagged, based on processing by one or more RPA bots operating on a filtered set of data records.

In operation 504, the server determines, for each of the flagged data records, a type of notification to generate. In some embodiments, the server may generate notifications that are intended for client entities associated with the data records. For example, a notification may indicate at least one of a certain property or condition associated with a data record (e.g., a loan default condition, payment overdue, etc.), recommendations of one or more follow-up actions in connection with the property/condition, and an associated due date by which the follow-up actions are required to be completed. In some embodiments, the server may generate notifications that are intended for third-party resource request and loan processing systems. Such notifications may indicate, for example, follow-up actions that are requested to be performed by the third-party system(s) and associated timelines for performing such follow-up actions. For example, a third-party system may be notified of a repossession request in connection with a resource loan for a particular data record/resource account that has been flagged.

The server then transmits the generated notifications to suitably identified computing devices, in operation 506. The notifications may be transmitted to devices associated with client entities. Additionally, or alternatively, the server may provide prompts for user input in connection with the notifications to client entities. The notifications may be transmitted to third-party computing systems for processing resource requests. In some embodiments, the server may transmit to an intermediary computing system that forwards the notifications to computing devices.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a communications module coupled to the processor; and
a memory coupled to the processor, the memory storing instructions that, when executed, configure the processor to:
obtain a filtered data record set based on filtering a set of a plurality of data records using first filter criteria;
determine, using a robotic process automation system, that a first data record in the filtered data record set is associated with a first category of data records, the robotic process automation system being configured to determine categories associated with respective data records using second filter criteria different from the first filter criteria; and
store, in the memory, a flag in association with the first data record, wherein flagging of the first data record causes a notification to be generated for transmission to a computing device associated with the first data record, the notification identifying an action to be taken in connection with the first data record.

2. The computing system of claim 1, wherein the filtered data record set includes only those data records that satisfy all defined criteria of the first filter criteria.

3. The computing system of claim 1, wherein the first filter criteria define a single payment delinquency period for all of the plurality of data records and wherein the second filter criteria define individualized payment delinquency periods for respective ones of the plurality of data records.

4. The computing system of claim 3, wherein the instructions, when executed, further configure the processor to determine an individualized payment delinquency period for at least one of the data records in the filtered data record set based on a risk rating associated with the at least one data record.

5. The computing system of claim 4, wherein the individualized payment delinquency period for the at least one data record is determined to be a shorter period if the at least one data record is associated with an entity that is associated with a high risk rating.

6. The computing system of claim 1, wherein the instructions, when executed, further configure the processor to automatically modify one or more defined criteria of the first filter criteria.

7. The computing system of claim 1, wherein the instructions, when executed, further configure the processor to:
determine that a data record in the filtered data record set has insufficient data for determining whether the data record belongs to the first category; and
add a record identifier associated with the data record to a defect list stored in the memory.

8. The computing system of claim 1, wherein evaluating data records using the second filter criteria comprises obtaining, from a remote server system, additional information in connection with the data records that is not stored in the memory.

9. The computing system of claim 8, wherein obtaining the additional information comprises transmitting one or more queries to the remote server system using application programming interface (API) calls.

10. The computing system of claim 1, wherein storing the flag in association with the first data record comprises indicating one or more defined conditions associated with the action, the one or more defined conditions being different from the second filter criteria.

11. A computer-implemented method, comprising:
obtaining a filtered data record set based on filtering a set of a plurality of data records using first filter criteria;
determining, using a robotic process automation system, that a first data record in the filtered data record set is associated with a first category of data records, the robotic process automation system being configured to determine categories associated with respective data records using second filter criteria different from the first filter criteria; and
store, in memory, a flag in association with the first data record, wherein flagging of the first data record causes a notification to be generated for transmission to a computing device associated with the first data record, the notification identifying an action to be taken in connection with the first data record.

12. The method of claim 11, wherein the filtered data record set includes only those data records that satisfy all defined criteria of the first filter criteria.

13. The method of claim 11, wherein the first filter criteria define a single payment delinquency period for all of the plurality of data records and wherein the second filter criteria define individualized payment delinquency periods for respective ones of the plurality of data records.

14. The method of claim 13, further comprising determining an individualized payment delinquency period for at least one of the data records in the filtered data record set based on a risk rating associated with the at least one data record.

15. The method of claim 14, wherein the individualized payment delinquency period for the at least one data record is determined to be a shorter period if the at least one data record is associated with an entity that is associated with a high risk rating.

16. The method of claim 11, further comprising automatically modifying one or more defined criteria of the first filter criteria.

17. The method of claim 11, further comprising:
determining that a data record in the filtered data record set has insufficient data for determining whether the data record belongs to the first category; and
adding a record identifier associated with the data record to a defect list stored in the memory.

18. The method of claim 11, wherein evaluating data records using the second filter criteria comprises obtaining, from a remote server system, additional information in connection with the data records that is not stored in the memory.

19. The method of claim 18, wherein obtaining the additional information comprises transmitting one or more queries to the remote server system using application programming interface (API) calls.

20. The method of claim 11, wherein storing the flag in association with the first data record comprises indicating one or more defined conditions associated with the action, the one or more defined conditions being different from the second filter criteria.
